(19) United States
(12) Patent Application Publication
(10) Pub. No.: US 2025/0065565 A1
(43) Pub. Date: Feb. 27, 2025

(54) Three-Dimensional Printing System with Build Area That is Larger than a Build Plane

(71) Applicant: 3D Systems, Inc., Rock Hill, SC (US)

(72) Inventor: Akarsh Sivaprasad, Nashua, NH (US)

(21) Appl. No.: 18/800,637

(22) Filed: Aug. 12, 2024

Related U.S. Application Data
(60) Provisional application No. 63/578,011, filed on Aug. 22, 2023.

(51) Int. Cl. B29C 64/255; B29C 64/129; B29C 64/236; B29C 64/277; B33Y 10/00; B33Y 30/00

(52) U.S. Cl. CPC B29C 64/255; B29C 64/129; B29C 64/236; B29C 64/277; B33Y 10/00; B33Y 30/00

(57) ABSTRACT

A 3D printing system includes a build vessel, a build platen, a projection light engine, a movement mechanism, and a controller. The build vessel is configured to contain a photocurable liquid. The build vessel includes a lower wall having an opening with an opening width along a lateral X-axis and a transparent sheet that closes the opening. The build platen has a a lower surface in facing relation with the transparent sheet. The build platen defines a platen width along a lateral X-axis that is greater than the opening width. The projection light engine is positioned below the build vessel. The projection light engine is configured to project pixelated radiation up to a build plane that is less than one millimeter above the transparent sheet.

### CROSS-REFERENCE TO RELATED APPLICATIONS

This non-provisional patent application claims priority to U.S. Provisional Application Ser. No. 63/578,011, Entitled “Three-Dimensional Printing System with Build Area That is Larger than a Build Plane” by Akarsh Sivaprasad, filed on Aug. 22, 2023, incorporated herein by reference under the benefit of U.S.C. 119(e).

### FIELD OF THE INVENTION

The present disclosure concerns an apparatus and method for manufacturing three-dimensional (3D) articles from photocurable liquids in a layer-by-layer manner. More particularly, the present disclosure concerns a way to fabricate layers over large areas with a relatively small build plane.

### BACKGROUND

Three dimensional (3D) printers are in rapidly increasing use for manufacturing customized 3D articles. A class of 3D printers includes stereolithography printers having a general principle of operation including the selective curing and hardening of radiation curable (i.e., photocurable) liquids. The 3D articles are formed in a layer-by-layer manner. In one “subclass” of stereolithography printers, a fluid reservoir that contains the photocurable liquid has a transparent sheet or plate on a lower side. A light engine, such as a projector, selectively projects pixelated radiation up through the transparent sheet to a “build plane” just above the transparent sheet. As individual layers are formed, a 3D article is raised by one layer thickness. There is an ongoing desire to build larger 3D articles having larger cross-sectional areas. One challenge is that the transparent sheet can sag under a column of the photocurable liquid. Another challenge is replenishing resin at the build plane between formation of layers.

### SUMMARY

A first aspect of the disclosure concerns a three-dimensional (3D) printing system configured to manufacture a 3D article. The 3D printing system includes a build vessel, a build platen, a projection light engine, a movement mechanism, and a controller. The build vessel is configured to contain a photocurable liquid. The build vessel includes a lower wall having an opening with an opening width along a lateral X-axis and a transparent sheet that closes the opening. The build platen has a lower surface in facing relation with the transparent sheet. The build platen defines a platen width along a lateral X-axis that is greater than the opening width. The projection light engine is positioned below the build vessel. The projection light engine is configured to project pixelated radiation up to a build plane that is less than one millimeter above the transparent sheet. The build plane has a lateral width along the lateral X-axis that is less than or equal to the opening width. The controller is configured to operate the movement mechanism to provide positioning of a first lateral end of the build platen over the build plane and to position a lower face of the 3D article at the build plane, operate the movement mechanism to impart relative motion between the build platen and the build plane along the lateral X-axis, and concurrent with imparting relative motion, operate the projection light engine to selectively and temporally irradiate the build plane and to selectively harden a layer of the photocurable liquid over the lower face of the 3D article over a lateral area that is larger than the lateral area of the build plane.

The disclosed system has at least three advantages over prior art systems. First it allows an unsupported width of the transparent sheet over the opening to be less than the width of a fabricated area. This allows for a relatively narrower unsupported width which reduces sag of the transparent sheet and therefore improves dimensional accuracy of fabrication. Second, with a smaller build plane, the projection light engine can define higher resolution layers. Third, the relative translation between the build platen and the build plane replenishes the photocurable fluid at the build plane.

In one implementation an upper surface of the lower wall of the build vessel has a floor length defined along the lateral X-axis. The floor length is at least two or three or four times the opening width. A larger multiple provides more distance for the build platen to scan and therefore increases a potential size of the 3D article as measured along the X-axis for a given opening width.

In another implementation an upper surface of the lower wall of the build vessel has a floor length defined along the lateral X-axis and a floor width defined along a lateral Y-axis. The opening has an opening length along the lateral Y-axis that is at least 70 percent of the floor width. The floor length is at least two times or three times the opening width.

In yet another implementation, the controller is configured to selectively harden a layer of the photocurable liquid over the lower face of the 3D article over a lateral area that is at least 50% or at least 100% larger than the lateral area of the build plane.

In a further implementation, the movement mechanism is configured to impart two axes of movement to the build platen including movement along the lateral X-axis and movement along a vertical Z-axis.

In a yet further implementation, the movement mechanism includes two spatially separated movement mechanisms including a first movement mechanism and a second movement mechanism. The first movement mechanism is configured to position and translate the build platen along a vertical Z-axis. The second movement mechanism is configured to impart positioning and translation of the build vessel and the projection light engine together in tandem (in fixed relationship to each other) along the lateral X-axis.

In another implementation, the movement mechanism includes three spatially separated movement mechanisms including a first movement mechanism, a second movement mechanism, and a third movement mechanism. The first movement mechanism is configured to position and translate the build platen along a vertical Z-axis. The second movement mechanism is configured to impart positioning and translation of the build vessel and the projection light engine together in tandem (in fixed relationship to each other) along the lateral X-axis. The third movement mechanism is configured to impart positioning and translation of the projection light engine with respect to the build vessel along the lateral Y-axis.

In yet another embodiment, the movement mechanism includes a ball bearing screw mechanism. The ball bearing screw mechanism includes a screw shaft threaded through a ball nut. The ball nut is attached to an object to be positioned and translated. The vertical screw shaft is coupled to a fixed motor. As the motor rotates the vertical screw shaft, the action causes the object to be translated.

In a further embodiment, the movement mechanism includes a lead screw mechanism. The lead screw mechanism includes a lead screw threaded through helical threads of a nut. The nut is attached to an object to be positioned and translated. The lead screw is coupled to a fixed motor. As the motor rotates the lead screw, the action causes the object to be translated.

In a yet further embodiment, the movement mechanism includes a multi-axis stage mechanism. Each axis of the movement mechanism includes a linear motor, a drive train (gears and or lead screw), and a linear bearing. Operating a motor independently translates an object along one axis.

In another embodiment, the controller includes a processor coupled to a non-transient or non-volatile information storage device. The information storage device stores software instructions that, when executed by the processor, perform controller operations including receiving information from sensors, operating the movement mechanism, and operating the projection light engine. Controllers are known by other names including microcontrollers, computers, computing devices, servers, and mainframe computers. The controller can be a single device or can include multiple and physically separated devices or even remotely located devices.

### BRIEF DESCRIPTION OF THE FIGURES

FIG. 1 is a schematic diagram depicting a first embodiment of a three-dimensional (3D) printing system.

FIG. 2 is a flowchart depicting a method of manufacturing a 3D article.

FIG. 3 is a schematic diagram depicting relative translation between a build vessel and a build platen.

FIG. 4 is a schematic diagram depicting relative positioning of a build platen with respect to a build vessel after a relative translation along an X-axis.

FIG. 5 is a schematic diagram depicting a second embodiment of a three-dimensional (3D) printing system.

FIG. 6 is an isometric drawing of the 3D printing system of FIG. 5.

FIG. 7 is a “top down” schematic plan view of a build vessel and a representation of a lower surface of a build platen superposed over the build vessel.

FIG. 8 is a schematic diagram depicting a third embodiment of a three-dimensional (3D) printing system.

FIG. 9 is a flowchart depicting a method of manufacturing a 3D article using the embodiment of FIG. 8.

### DETAILED DESCRIPTION OF THE PREFERRED EMBODIMENTS

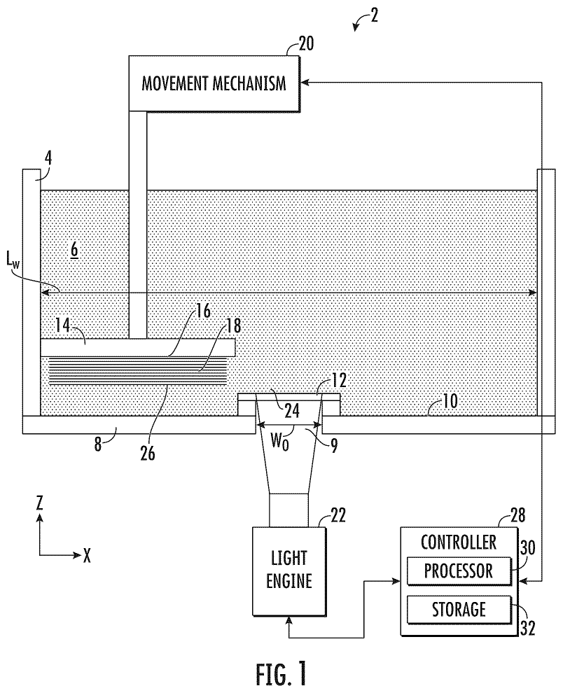

FIG. 1 is a schematic drawing depicting a first embodiment of three-dimensional (3D) printing system 2. In describing 3D printing system 2, mutually perpendicular axes X, Y, and Z will be used. Axes X and Y are generally horizontal lateral axes. Axis Z is a vertical axis that is generally aligned with a gravitational reference. In using the word “generally” it is implied that a limitation that is “generally” true is by design but to within manufacturing tolerances. Additionally angular axes theta-X, theta-Y, and theta-Z are rotations about the X, Y, and Z axes respectively.

3D printing system 2 includes a build vessel 4 configured to contain a photocurable liquid 6. Generally speaking, the photocurable liquid 6 includes a monomer and a catalyst. When exposed with radiation in a blue to ultraviolet range—or having a wavelength of 100 to 500 nanometers (nm)—the photocurable liquid 6 will harden as the monomer polymerizes or crosslinks. Some photocurable liquids 6 can be photocurable resins having an organic solvent vehicle. Others are hydrogels which contain a water solvent vehicle.

Build vessel 4 includes a lower wall 8 that forms a lower end of the build vessel 4. The lower wall 8 has a length L_{w} along a lateral X-axis that can be measured along an inside or upward facing surface 10 of the lower wall 8. The lower wall also has a central opening 9 that is closed by a transparent sheet 12. The central opening has a width Wₒ along lateral X-axis. The length L_{w} is at least twice that of the width Wₒ. The lower wall 8 can be formed from an optically opaque material such as aluminum, stainless steel, or titanium.

The transparent sheet 12 is “transparent” or optically clear with respect to transmission of blue, violet, or ultraviolet radiation that can have a wavelength within a range of 100 to 500 nanometers (nm). The transparent sheet is preferably “semipermeable” meaning that it is permeable to at least oxygen. One example of a suitable transparent sheet is a fluoropolymer with optical clarity and gas permeability such as Teflon™ AF 2400. Other polymeric sheet materials can be suitable for the particular application.

A build platen 14 is supported within the build vessel 4. Build platen 14 has a lower surface 16 in which a 3D article 18 is to be fabricated in a layer-by-layer manner. The lower surface 16 of the build platen 14 has lateral area that is larger than a lateral area of the opening 9. This allows for the fabrication of a large 3D article 18 with a relatively small area transparent sheet 12. In the illustrated embodiment, the lateral area of the lower surface 16 is at least twice the lateral area of the opening 9.

In the illustrated embodiment, a movement mechanism 20 is coupled to the build platen 14. In the first embodiment, the movement mechanism 20 is a two-axis movement mechanism configured to position and translate the build platen over a horizontal X-axis and a vertical Z-axis.

An embodiment of the movement mechanism 20 for motion along X and Z axes includes an “XZ stage”. The movement mechanism can include two linear motors acting at right angles to each other including an “X-motor” and a “Z-motor”. The motors can drive screw or gear mechanisms that provide linear translation of the stage along the X and Z axes. A drive screw mechanism includes a lead screw that is threaded into a nut that is coupled to the build platen. Motor rotation of the lead screw imparts linear motion of the build platen for each axis. XZ stages, lead screw mechanisms, and gear mechanisms are known in the art for 3D printing and precision dispensing systems in one, two, or three dimensions. For a lead screw system embodiment, there would be a combination of a motor, lead screw, and nut for each dimension. Other embodiments such as rack and pinion systems and belt and pulley systems can be used for one or both axes X and Z.

A projection light engine 22 is positioned below the build vessel 4 and configured to selectively irradiate a build plane 24 that is coplanar with the lower face 26 of the 3D article 18. A location of the light engine 22 can be fixed with respect to the build vessel 4 and therefore with the central opening 9. The build plane 24 has an area that is similar to that of the opening 9 and therefore smaller in area than the lower surface 16 of build platen 14.

In one embodiment, the light engine 22 includes, inter alia, a light source, a spatial light modulator, and projection optics. The light source emits radiation in the blue to ultraviolet range or with a wavelength between 100 and 500 nm. The light source can be an arc lamp or an LED (light emitting diode) array to name two examples. The spatial light modulator can include a micromirror array with micromirrors that can be individually controlled to reflect a pixel of light either through the projection optics or to a light trap. Such projection units are used and known within the field of stereolithography. In alternative embodiments, the projection unit can use other spatial light modulators that are based upon other principles such as liquid crystal arrays in series with polarization filters which are also known in the art.

In some embodiments, the light engine 22 can include a row of light engines arranged along the lateral Y-axis. The opening 9 is elongate along the Y-axis. It is preferred that the pixels projected onto the build plane 24 be square or nearly square so that a resolution is equal along the lateral X and Y axes.

A controller 28 is coupled to the movement mechanism 20, the light engine 22, and other components of the 3D printing system 2. Such other components can include sensors for sensing a fluid level or fluid height of the photocurable liquid 6 within the build vessel 4. The controller 28 includes a processor 30 coupled to a non-volatile or non-transient storage device 32. The storage device 32 stores software instructions that, when executed by the processor 30, control various portions of the 3D printing system 2. The controller 28 can be a single module co-located with the 3D printing system 2 and/or include modules, computers, and/or servers that are spaced or remote from printing system 2. Controllers including processors and storage subsystems are known in the art for control of electromechanical systems for various applications including 3D printing.

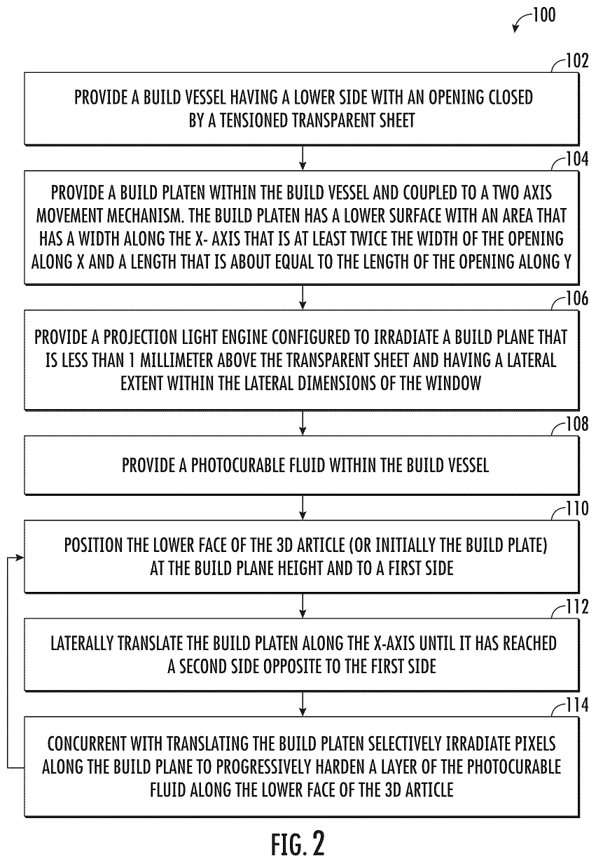

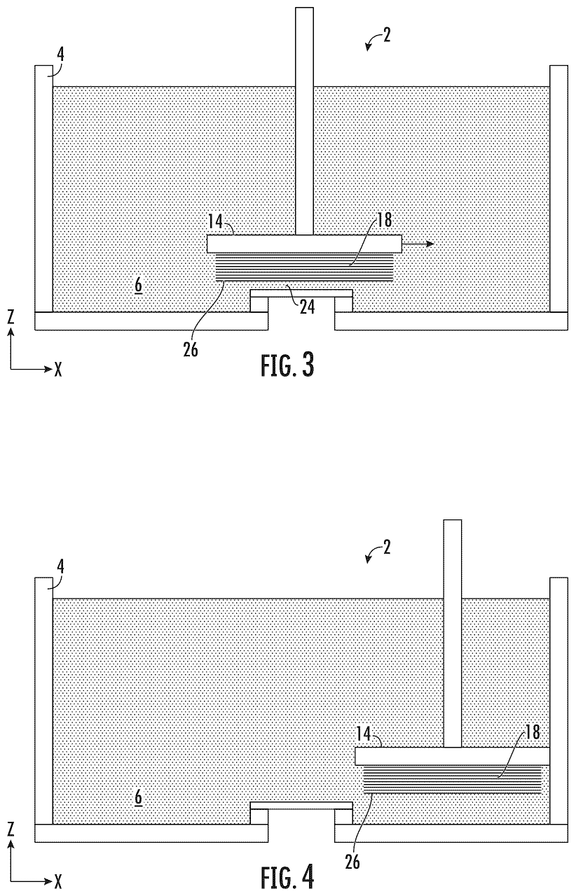

FIG. 2 is a flowchart of a method 100 of manufacturing the three-dimensional (3D) article 18. FIGS. 3 and 4 schematic drawings of a portion of the 3D printing system 2. In combination with FIG. 1, FIGS. 3 and 4 help to illustrate steps 110 and 112 of method 100.

Steps 102-108 are preparatory steps prior to fabrication of the 3D article 18. According to step 102, the build vessel 4 is provided having the opening 9 closed by the transparent sheet 12. According to 104, the build platen 14 is positioned within the build vessel 4. According to 106, a projection light engine is provided and is configured to project radiation to the build plane 24. According to 108, a photocurable fluid 6 is provided within the build vessel 4. As a note, the exact ordering of steps 102-108 are immaterial as these are providing steps that can occur at any time before subsequent steps.

According to step 110, the lower face 26 of the 3D article (or initially the lower surface or face 16 of the build platen) is positioned coplanar with the vertical height of the build plane 24 but over to one side along the X-axis. The positioning of step 110 is illustrated in FIG. 1.

According to 112, the build platen 14 is laterally translated in the +X direction which is illustrated in FIG. 3. The lateral translation continues until the lower face 26 of the 3D article reaches a second side of the build plane 24 which is opposite to the first side. This is illustrated in FIG. 4.

According to 114, concurrently with 112, the projection light engine 22 is operated to selectively irradiate pixels at the build plane in order to progressively and selectively harden a layer of the photocurable fluid 6 along and onto the lower face 26 of the 3D article 18. Steps 110-114 are repeated until fabrication of the 3D article 18 is complete. As a note, motion during repeated steps of 112 can be back and forth between the two sides of the build plane.

In a bidirectional embodiment of method 100, step 112 can initially be in the +X direction during a first execution of steps 110-114. Immediately after reaching the state illustrated in FIG. 4, a second execution of steps 110-114 can include motion along the −X direction during step 112. A third execution of steps 110-114 can include motion in the +X direction during step 112. This method of operation can be referred to as “bidirectional printing” because printing occurs alternately in two opposing directions.

In a unidirectional embodiment of method 100, step 110 includes non-printing motion in the −X direction before executing steps 112 and 114. This method of operation can be referred to as “unidirectional printing” because printing only occurs with motion along the +X direction.

In a continuous embodiment of method 100, steps 112 and 114 occur concurrently with continuous or non-halting motion along the X-axis. A continuous embodiment can be bidirectional or unidirectional.

In a stepped embodiment of method 100, step 112 includes incrementally stepped motion along the X-axis then a motionless pause. During each motionless pause, step 114 is performed. A stepped embodiment can be bidirectional or unidirectional.

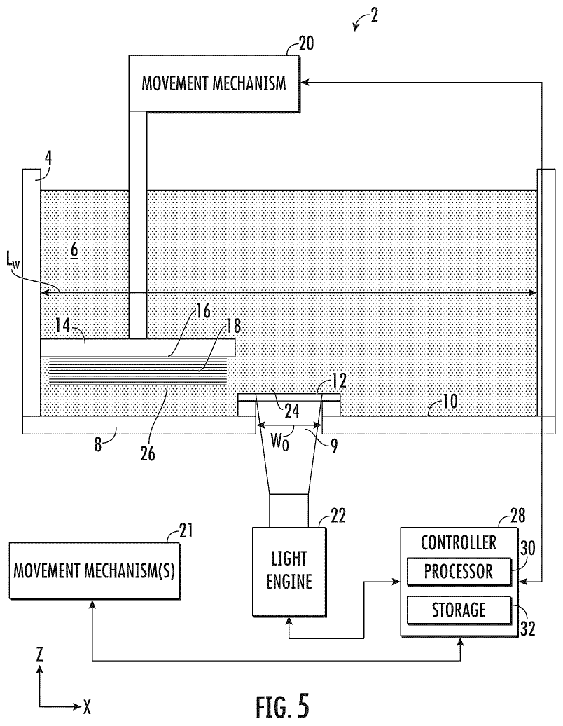

FIG. 5 is a schematic diagram of a second embodiment of 3D printing system 2. With the exception of movement mechanisms 20 and 21, like element numbers indicate like elements. Therefore, only elements with differences will be discussed infra.

The second embodiment of FIG. 5 differs from the embodiment of FIG. 1 in two ways. First, movement mechanism 20 is configured to position, move, and translate the build platen 14 along the vertical Z axis. Another movement mechanism 21 is tandemly coupled to the build vessel 4 and the light engine 22. The build vessel 4 and the light engine 22 are fixed with respect to each other along the X-axis. Movement mechanism 21 is configured to tandemly position, move, and translate the tandem combination of the build vessel 4 and the light engine 22 along the X-axis.

A second embodiment of the method of FIG. 2 can apply to the 3D printing system 2 of FIG. 5. During step 110, the movement mechanisms 20 and 21 act independently to provide the relative positioning of the build platen 14 with respect to the build vessel 4 (in which the relative movement along the X-axis is caused by the movement of the build vessel 4 in tandem with the light engine 22). During step 112, the movement along the X-axis is the tandem motion of the build vessel 4 and light engine 22. FIGS. 3 and 4 still apply as representations of the relative movement of the build platen 14 with respect to the build vessel 4. As before, printing can be bidirectional or unidirectional as discussed supra. Also, printing can be continuous or stepped as discussed supra.

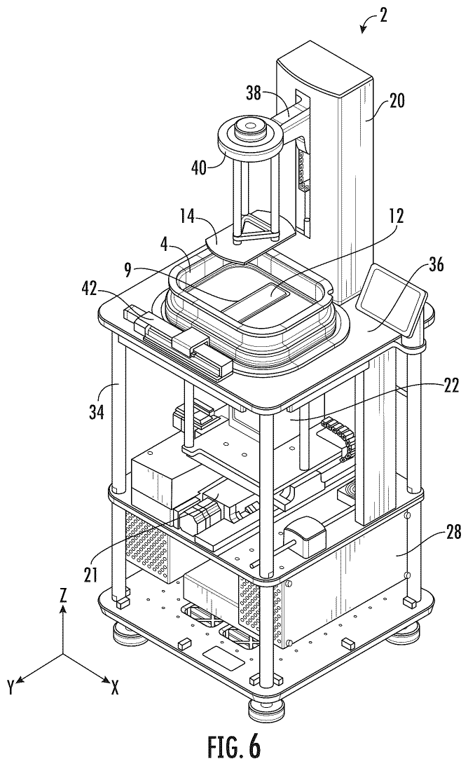

FIG. 6 is an isometric drawing of an embodiment of the 3D printing system 2 which corresponds to the embodiment of FIG. 5. Relative to earlier figures, like element numbers indicate like elements. A chassis 34 provides support for various components of the 3D printing system 2 and includes a support platform 36 for supporting the build vessel 4. The lower side 8 of build vessel 4 defines opening 9 closed by transparent sheet 12.

In the illustrated embodiment, movement mechanism 20 is coupled to an elevator 38 which in turn supports build platform 40. Build platform 40 includes build platen 14 which is in facing relation with the transparent sheet 12. Movement mechanism 20 is configured to position the build platen 14 along the vertical Z-axis. Movement mechanism 20 includes a ball bearing screw mechanism or otherwise referred to as a ball screw mechanism. A ball screw mechanism includes a vertical screw shaft that passes through a ball nut. The ball nut contains recirculating steel balls and translates vertically. The vertical screw shaft has helical channels that engage the recirculating balls. The elevator 38 includes the ball nut. A motor is coupled to the vertical screw shaft and is configured to selectively rotate the vertical screw shaft. As the vertical screw shaft rotates, the action of the vertical screw shaft upon the ball nut translates the elevator upward and downward depending on a direction of rotation.

Chassis 34 supports the light engine 22 below the support platform 36. The projection light engine 22 is in a fixed mechanical relation to the build vessel 4 along the X-axis. A linear bearing 42 constrains tandem motion of the build vessel 4 and the projection light engine 22 to move along the X-axis. Movement mechanism 21 is coupled to the light engine 22 and build vessel 4 and is configured to position and translate the tandem combination 4, 22 along the X-axis. In the illustrated embodiment, movement mechanism 21 includes a motor coupled to a linear stage. In one embodiment motor generates movement of the stage (and thus tandem movement of build vessel 4 and light engine 22) by driving a lead screw that imparts the motion along the X-axis. Alternatively, the motor drives a gear train that imparts the motion. The gear train can include a gear reduction mechanism coupled to a pinion gear. A linear track gear upon the stage can be driven by the pinion gear. Such mechanisms are known in the art for imparting linear motion.

Thus, in the illustrated embodiment, relative motion between the build vessel and the build platen is imparted by a combination of movement mechanisms 20 and 21 for relative motion in Z and X respectively. Controller 28 is coupled to movement mechanisms 20 and 21 and to projection light engine 22 to carry out repeated steps 110 to 114 of method 100.

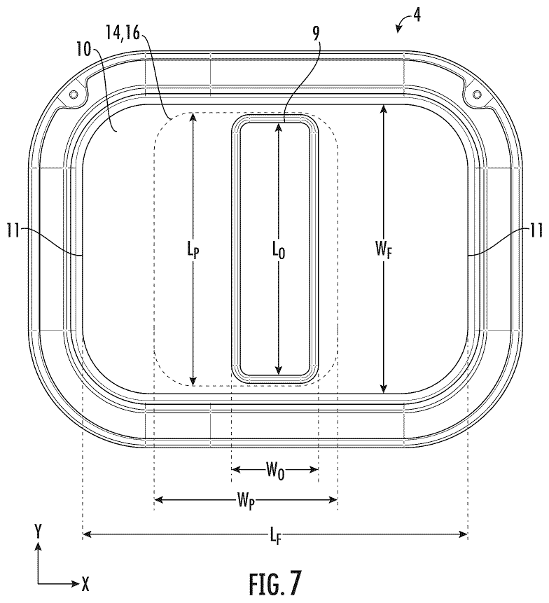

FIG. 7 is a “top down” schematic plan view of the build vessel 4 (looking in the −Z direction). Superposed upon the build vessel 4 is the build platen 14 lower surface 16. The purpose of this figure is to define and quantify certain important dimensions for a particular embodiment of build vessel 4 and build platen 14.

The build vessel 4 has a lower wall 8 (the bottom of build vessel 4) with an upward facing surface 10 which is hereafter referred to as floor 10. Floor 10 has a length L_{F} along the X-axis and a width W_{F} along the Y-axis. As described with respect to FIG. 1, the lower wall 8 has or defines an opening 9. Opening 9 has a width W_{O} along the X-axis and a length L_{O} along the Y-axis. The lower surface 16 of the platen 14 has a width W_{P} along the X-axis and a length L_{P} along the Y-axis.

The width W_{P} of the platen is greater than the width W_{O} of the opening 9. This has the advantage that the 3D article 18 being manufactured can have a width along X that is greater than the width of the opening 9. In some embodiments W_{P} is at least two times W_{O} or even at least three times W_{O}. Thus, a relatively small unsupported area of the transparent sheet 12 can be used to fabricate an article having considerably larger cross-sectional area.

To accommodate relative motion along X between the build platen 14 and the opening 9, the floor length L_{F} has to be considerably larger than the width of the build platen W_{P}. The floor length L_{F} can be at least two times, three times four times, or five times the opening 9 width W_{O}. Preferably, a distance along the X-axis between the window 9 and an end 11 of the floor 10 is at least equal to the width W_{P} of the platen 14.

To maximize the Y-dimension of the 3D article, the opening 9 has a length L_{O} that is at least 70% of the floor width W_{F}. Ideally L_{O} is as close as possible to W_{F}. In the illustrated embodiment, the opening length L_{O} is roughly equal to the platen length L_{P}.

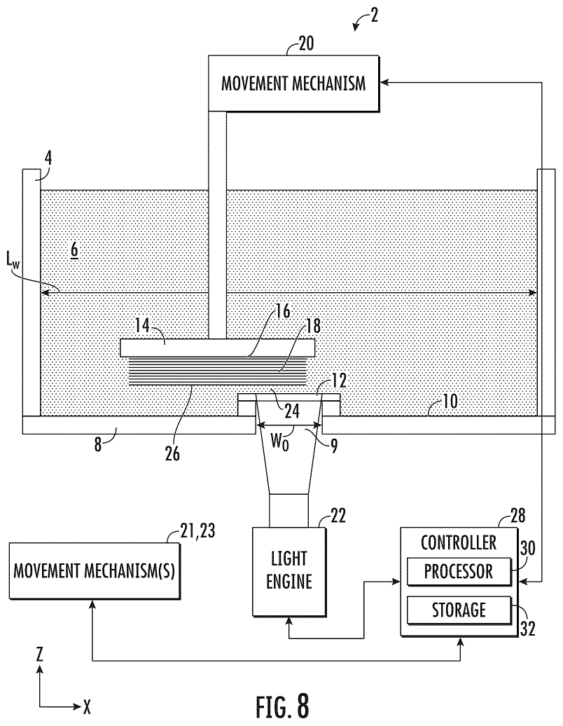

FIG. 8 is a schematic diagram of a third embodiment of 3D printing system 2. The embodiment of FIG. 8 is like in all respects to earlier figures except for inclusion of three movement mechanisms 20, 21, and 23. Thus, discussion of the other elements is not included. Movement mechanism 20 is configured to position, move, and translate the build platen along the Z-axis. Movement mechanism 21 is configured to position, move, and translate the tandem combination of the build vessel 4 and the light engine 22 with respect to the lateral X-axis. Movement mechanism 23 is configured to position, move, and translate the light engine 22 with respect to the build vessel along the lateral Y-axis. For the embodiment of FIG. 8, the light engine is only capable of imaging a portion or tile of the build plane 24 at one time.

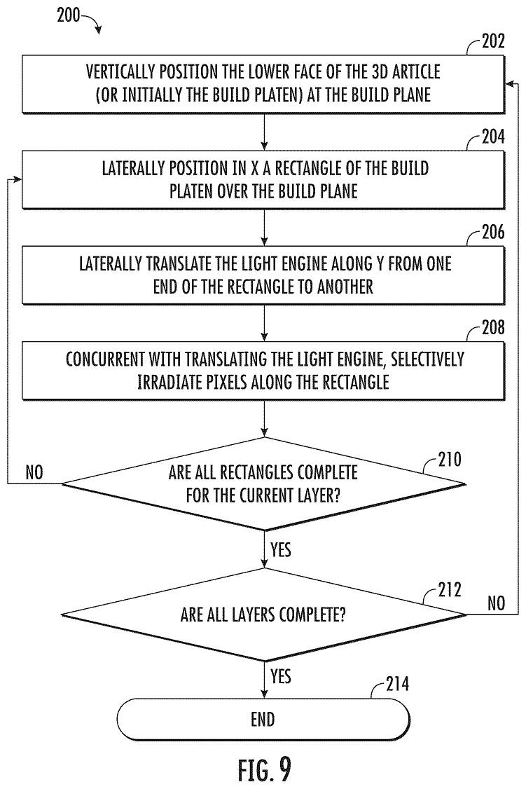

FIG. 9 is a flowchart depicting a method of manufacturing a 3D article 18 with the third 3D printing system 2 embodiment of FIG. 8. Some preparatory steps (steps 102-108 of FIG. 2) are skipped since these are common to all embodiments of 3D printing system 2. Steps 202-214 are performed automatically by the controller 28 of FIG. 8.

According to 202, movement mechanism 20 is operated to vertically position the lower face 26 of the 3D article 18 (or initially the lower surface of the build platen 14) coplanar with the build plane 24 vertical position. According to 204, the movement mechanism 21 is operated to position a tile or rectangle of the build platen 14 over the build plane 24. Step 204 includes a repositioning of the tandem (fixed with respect to each other) combination of the build vessel 4 and light engine 22 along the X-axis.

According to 206, the movement mechanism 23 is operated to translate or scan the light engine 22 relative to the build vessel 4 along the Y-axis and from one end of the opening 9 to another. According to 208—concurrent with step 206, the light engine 22 is operated to selectively irradiate pixels along the build plane 24 during the scanning.

According to 210, a determination is made as to whether all rectangles or tiles for the current slice are selectively irradiated. If not, the process loops back to step 204. Steps 204-208 are repeated until the entire slice is selectively irradiated. Then the process moves to step 212.

According to 212, a determination is made as to whether all slices for the 3D article 18 are formed. If not, the process loops back to 204. Steps 204-210 are repeated until fabrication of the 3D article 18 is complete. When all slices are formed, the process terminates according to step 214.

The specific embodiments and applications thereof described above are for illustrative purposes only and do not preclude modifications and variations encompassed by the scope of the following claims.

What is claimed:

1. A three-dimensional (3D) printing system configured to manufacture a 3D article comprising:
a build vessel configured to contain a photocurable liquid, the build vessel including:
a lower wall having an opening with an opening width along a lateral X-axis; and
a transparent sheet that closes the opening;
a build platen having a lower surface in facing relation with the transparent sheet and having a platen width along the lateral X-axis, the platen width is greater than the opening width;
a projection light engine below the build vessel and configured to project pixelated radiation up to a build plane that is less than one millimeter above the transparent sheet, the build plane having a lateral width along the lateral X-axis that is less than or equal to the opening width;
a movement mechanism;
a controller configured to:
operate the movement mechanism to provide positioning of a first lateral end of the build platen over the build plane and to position a lower face of the 3D article coplanar with the build plane;
operate the movement mechanism to impart relative motion between the build platen and the build plane along the lateral X-axis; and
concurrent with imparting relative motion, operate the projection light engine to selectively and temporally irradiate the build plane and to selectively harden a layer of the photocurable liquid over the lower face of the 3D article over a lateral area that is larger than the lateral area of the build plane.

2. The three-dimensional (3D) printing system of claim 1 wherein an upper surface of the lower wall of the build vessel has a floor length along the lateral X-axis, the floor length is at least two times the opening width.

3. The three-dimensional (3D) printing system of claim 2 wherein the floor length is at least three times the opening width.

4. The three-dimensional (3D) printing system of claim 3 wherein the floor length is at least four times the opening width.

5. The three-dimensional (3D) printing system of claim 1 wherein the lower wall of the build vessel has a floor length along the lateral X-axis and a floor width along the lateral Y-axis, the opening has an opening length along the lateral Y-axis, the opening length is at least 70 percent of the floor width, floor length is at least two times the opening width.

6. The three-dimensional (3D) printing system of claim 5 wherein the floor length is at least three times the opening width.

7. The three-dimensional (3D) printing system of claim 1 wherein the controller is configured to selectively harden a layer of the photocurable liquid over the lower face of the 3D article over a lateral area that is at least 50% larger than the lateral area of the build plane.

8. The three-dimensional (3D) printing system of claim 1 wherein the controller is configured to selectively harden a layer of the photocurable liquid over the lower face of the 3D article over a lateral area that is at least 100% larger than the lateral area of the build plane.

9. The three-dimensional (3D) printing system of claim 1 wherein the movement mechanism is configured to impart both vertical and lateral movement to the build platen.

10. The three-dimensional (3D) printing system of claim 1 wherein the movement mechanism is configured to impart vertical movement of the build platen and impart lateral movement to the build vessel and the projection light engine with the build vessel and the projection light engine in fixed relation to each other along the X-axis.

11. A method of manufacturing a three-dimensional (3D) article comprising:
providing a three-dimensional printing system configured to manufacture a 3D article which includes:
a build vessel configured to contain a photocurable liquid, the build vessel including:
a lower wall having an opening with an opening width along a lateral X-axis; and
a transparent sheet that closes the opening;
a build platen having a lower surface in facing relation with the transparent sheet and having a platen width along the lateral X-axis, the platen width is greater than the opening width;
a projection light engine below the build vessel and configured to project pixelated radiation up to a build plane that is less than one millimeter above the transparent sheet, the build plane having a lateral width along the lateral X-axis that is less than or equal to the opening width;
a movement mechanism;
operating the movement mechanism to position a first lateral end of the build platen over the build plane and to position a lower face of the 3D article coplanar with the build plane;
operating the movement mechanism to impart relative motion between the build platen and the build plane along the lateral X-axis; and
concurrent with imparting relative motion, operating the projection light engine to selectively and temporally irradiate the build plane and to selectively harden a layer of the photocurable liquid over the lower face of the 3D article over a lateral area that is larger than the lateral area of the build plane.

12. The method of claim 11 wherein the layer of photocurable liquid is selectively hardened over a lateral area that is at least 50% larger than the lateral area of the build plane.

13. The method of claim 11 wherein the layer of photocurable liquid is selectively hardened over a lateral area that is at least 100% larger than the lateral area of the build plane.

14. The method of claim 11 wherein operating the movement mechanism includes vertically and laterally moving the build plate.

15. The method of claim 11 wherein operating the movement mechanism includes vertically moving the build platen and horizontally translating a tandem combination of the build vessel and the light engine.

16. A three-dimensional (3D) printing system configured to manufacture a 3D article comprising:
a build vessel configured to contain a photocurable liquid, the build vessel including:
a lower wall having a floor length and width along mutually perpendicular X-axis and Y-axis respectively, the lower wall defining an opening with an opening width along the lateral X axis that is less than a third of the floor length and an opening length along the lateral Y-axis that is at least 70% of the floor width; and
a transparent sheet that closes the opening;
a build platen having a lower surface in facing relation with the transparent sheet and having a platen width along the lateral X-axis, the platen width is greater than the opening width;
a projection light engine below the build vessel and configured to project pixelated radiation up to a build plane that is less than one millimeter above the transparent sheet, the build plane having a lateral width along the lateral X-axis that is less than or equal to the opening width;
a movement mechanism;
a controller configured to:
operate the movement mechanism to provide positioning of a first lateral end of the build platen over the build plane and to position a lower face of the 3D article coplanar with the build plane;
operate the movement mechanism to impart relative motion between the build platen and the build plane along the lateral X-axis; and
concurrent with imparting relative motion, operate the projection light engine to selectively and temporally irradiate the build plane and to selectively harden a layer of the photocurable liquid over the lower face of the 3D article over a lateral area that is larger than the lateral area of the build plane.

17. The three-dimensional (3D) printing system of claim 16 wherein the controller is configured to selectively harden a layer of the photocurable liquid over the lower face of the 3D article over a lateral area that is at least 50% larger than the lateral area of the build plane.

18. The three-dimensional (3D) printing system of claim 16 wherein the controller is configured to selectively harden a layer of the photocurable liquid over the lower face of the 3D article over a lateral area that is at least 100% larger than the lateral area of the build plane.

19. The three-dimensional (3D) printing system of claim 16 wherein the movement mechanism is configured to impart both vertical and lateral movement to the build platen.

20. The three-dimensional (3D) printing system of claim 16 wherein the movement mechanism includes a first movement mechanism configured to position the build platen with respect to the Z-axis and a second movement mechanism configured to move the build platen and the projection light engine together and in fixed relationship to each other with respect to the X-axis.
